(19) United States
(12) Patent Application Publication
(10) Pub. No.: US 2018/0210819 A1
(43) Pub. Date: Jul. 26, 2018

(54) SYSTEM AND METHOD OF CONTROLLING A WEB BROWSER PLUG-IN FOR TESTING ANALYTICS

(71) Applicant: Macy's West Stores, Inc., Cincinnati, OH (US)

(72) Inventors: Chang Hoon JUNG, Palo Alto, CA (US); Phan Phu Thanh DO, Fremont, CA (US)

(21) Appl. No.: 15/414,784

(22) Filed: Jan. 25, 2017

(51) Int. Cl. G06F 11/36; G06F 17/30

(52) U.S. Cl. CPC G06F 11/3668; G06F 17/3089

(57) ABSTRACT

A method of testing a web browser plug-in including the steps of: creating a master key identifying all possible values from activities on a website which are desired to be recorded and passing those values to a database controlled by the web browser plug-in; using one or more processors, switching control between the web browser and plug-in to execute all possible activities on a website which are desired to be recorded, passing those values to the database controlled by the web browser plug-in; and comparing the values obtained from the web browser plug-in with the master key values. Any received value that does not match the master key value is flagged for correction by the website programmer.

### FIELD OF THE INVENTION

The present invention generally relates to a web browser plug-in, and more particularly, systems and methods for testing of a web browser plug-in designed to capture user actions on a web page open on the web browser.

### BACKGROUND OF THE INVENTION

Internet web browsers, such as Microsoft Internet Explorer, Mozilla Firefox or Google Chrome, are configured to work with browser plug-ins. Browser plug-ins are software modules that add specific functionalities to host applications such as web browsers. For example, the Adobe Acrobat Reader plug-in enables the reading of documents saved in the portable document format (“PDF”) in web browsers.

One common use of Internet web browsers is to conduct electronic commerce (“e-commerce”) on a website opened in a web browser. Internet retail websites are ubiquitous. There is a need for retailers operating these websites to analyze consumer activity on the website. This activity could then be analyzed by the retailer for marketing and analysis purposes, for example, to improve a customer's browsing experience and to improve traffic to and sales on the website.

To meet this need, browser plug-ins have been designed to gather information on a customer's web browsing activities including, for example, on an e-commerce website (the “Analytical Plug-In”). One such Analytical Plug-In is IBM® Digital Analytics from IBM Corp.

The Analytical Plug-In captures a user's interactions on the e-commerce website and stores that data for later analysis. One way of capturing these activities is by assigning tags to portions of the e-commerce website. These tags receive a value when the user interacts on the web site which can then be passed to the Analytical Plug-In for subsequent analysis. Browser plug-ins may come with a library of tags which can be assigned by the website developer to portions of the web pages during creation of the website.

FIG. 1 is a simplified block diagram of web browser 115 configured to work with the Analytical Plug-In. Web browser 115 shows webpage 100 of a sample e-commerce website offering a shirt and pants for sale, and a frame containing plug-in 110. As shown in FIG. 1, three tags have been created for (1) website address 101; (2) pants 105; and (3) shirt 103. Though the tag values are shown in webpage 100 for illustrative purposes, these values are not actually visible on website 100, but are instead located within the code for the web page.

These tags are populated with values based on the actions of the consumer which are then recorded by the Analytical Plug-In. For example, when the user goes to the web address 101 of the e-commerce website, the corresponding tag value (i.e., “home page” 112) is passed to the plug-in 110 for subsequent web metric analysis. Similarly, clicking on shirt 103 and pants 105 would pass tag value 114 (“shirt”) and tag value 116 (“pants”) to plug-in 110. While the tag values shown in FIG. 1 are static values, at times the values are dynamic and the expected values are not known until the user interactions are simulated and the value is recorded.

When the web pages are being created, there is a need to confirm that the tag values being passed to the plug-in are the expected values. In order to make sure that plug-in 110 is accurately recording the consumer activity on web page 100, testing needs to be done to validate the anticipated tag values. This validation testing can be accomplished by an individual first determining the anticipated tag values, which can be referred to as master key values. In cases where the tag value is a dynamic value, the master key value may simply represent the existence of a value, as opposed to the absence of a value. With a limited number of tag values, an individual could manually recreate the anticipated steps within webpage 100 to receive the tag values which are recorded by plug-in 110. These values would then be compared with the master key values and if the values match, then the plug-in has been validated.

In FIG. 1, there are only three tags for illustrative purposes. However, in a typical e-commerce website, there can be thousands of tag values on hundreds of web pages associated with an e-commerce retailer. Further, every time the web pages are modified with new offerings, pricing, etc., a circumstance that frequently occurs on e-commerce web sites, the plug-in must be revalidated. Accordingly, verifying the tag values as described above not practical. There is a need for providing a technical solution to the technical problem of efficiently verifying that the tag values associated with the e-commerce web site are recorded properly on the web browser plug-in.

### SUMMARY OF THE INVENTION

Systems and methods for testing of an analytical web browser plug-including switching between the web page and the plug-in are provided.

A method according to an exemplary embodiment of the present invention comprises the steps of: establishing master key values for web page tags; storing the master key values in a database; using one or more processors to control actions on a web page to execute all possible activities to generate tag values on a website which are desired to be recorded; passing those values to the web browser plug-in; using one or more processors to switch control from the webpage to the web browser plug-in; using the plug-in controller to pass the tag values to a new data database; and comparing the values obtained from the web browser plug-in with the master key values.

Any received value that does not match the master key value is flagged for correction by the website programmer.

In a preferred embodiment, the master key values are automatically generated by running the web browser test automation system and passing the tag values received by the plug-in to the database storing the master key values.

A system according to one exemplary embodiment of the present invention comprises: at least one database, at least one processor; at least one non-transitory processor readable medium operatively connected to at least one processor and at least one database having processor readable instructions stored thereon which, when executed by the at least one processor, cause the at least one processor to perform the following method: simulating, using one or more processors, a user's web page movements using a web page controller to generate tag values equivalent to selected portions of an internet web page; passing, using one or more processors, the tag values to the web browser plug-in; passing, using one or more processors, web browser plug-in tag values to a database using a plug-in controller, wherein control between the web page controller and plug-in controller is switched by a web page/plug-in switcher using one or more processors; comparing, using one or more processors, the web browser plug-in tag values to master key values previously stored in a database.

A system according to one exemplary embodiment of the present invention comprises: at least one database, at least one processor; at least one non-transitory processor readable medium operatively connected to at least one processor and at least one database having processor readable instructions stored thereon which, when executed by the at least one processor, cause the at least one processor to perform the following method: simulating, using one or more processors, a user's web page movements using a web page controller to generate tag values equivalent to various portions of an internet web page; passing, using one or more processors, the tag values to the web browser plug-in; passing, using one or more processors, web browser plug-in tag values to a database using a plug-in controller, wherein control from the web page controller to the plug-in controller is switched by a web page/plug-in switcher using one or more processors; evaluating the tag values to determine whether they are expected tag values; correcting any tag values in the database which were not expected values to the expected values; storing the expected tag values as master key values in the database; switching, using the web page/plug-in switcher using one or more processors, control from the plug-in controller to the web page controller; executing, using one or more processors, a second round of web page movements to generate a second round of tag values equivalent to various portions of an internet web page; passing, using one or more processors, the tag values to the web browser plug-in; passing, using one or more processors, web browser plug-in tag values to a database using a plug-in controller, wherein control of the web page movements to the plug-in controller is switched by the web page/plug-in switcher using one or more processors; storing the tag values as new data values in the database; comparing, using one or more processors, the master key values in the database to the new data values in the database.

These and other features of this invention are described in, or are apparent from, the following detailed description of various exemplary embodiments of this invention.

### BRIEF DESCRIPTION OF THE DRAWINGS

The features and advantages of the present invention will be more fully understood by reference to the following detailed description of illustrative embodiments of the present invention when taken in conjunction with the following figures, wherein:

FIG. 1 is an illustration of a sample website and web-browser plug-in recording tag values received from the internet website as exists in the prior art;

FIG. 2 is a schematic diagram of the web-browser plug-in testing software architecture in accordance with exemplary embodiments of the present invention; and

FIG. 3 is a high level flow chart of the prior art process for creating the master key tag values;

FIG. 4 is a high level flowchart of the web browser plug-in test protocol; and

FIG. 5 is a high level flowchart of the combined process of master key tag value creation and web browser plug-in test.

### DETAILED DESCRIPTION

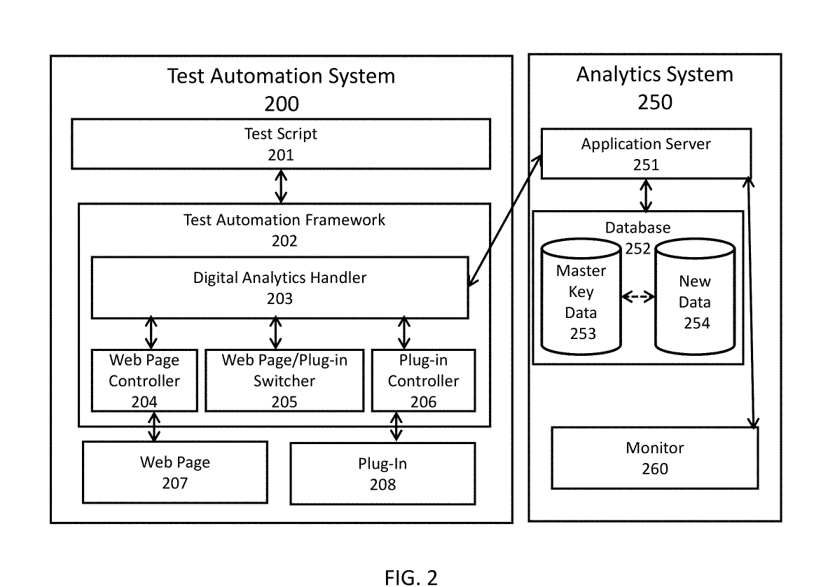

Embodiments of the present invention may be implemented as part of an e-commerce website and a plug-in designed to capture user interactions on that website as shown in FIGS. 2-5.

With reference to FIG. 2, the web browser plug-in testing system comprises test automation system 200 and analytics system 250.

Test automation system 200 and analytics system 250 may be implemented using one or more computer systems including one or more processors, one or more memory devices, one or more communication interfaces, and one or more persistent storage devices, including, one or more non-transitory computer readable media including computer-readable code containing instructions for the one or more processors to perform processing steps. The one or more computer systems may form part of a network, such as a local area network or a wide area network, such as, for example, the Internet. In exemplary embodiments, the one or more computer systems may include standard hardware components and/or specialized hardware components.

It is possible for test automation system 200 and analytics system 250 to be implemented using only one computer. However, because of the vast number of tests that must be run on the computer, such a setup is not practical.

Where the number of tests is not practical to run on one computer, one of ordinary skill in the art would recognize that multiple computer processors, either physical computers with computer processors or virtual machines operating on either one computer or within the internet cloud can be set up to collectively run portions of the testing scenario so that it may be undertaken within a reasonable time. In order to split up the testing onto multiple machines, task assigning software such as Jenkins automation software, available at Jenkins.io, may be used to conduct parallel execution of the tests. Each virtual machine would have the test automation framework 202 installed. Test results from each machine or virtual machine would be passed through the task assigning software to analytics system 250.

Referring to FIG. 2, test script 201 is created to initiate the web browser plug-in testing system. In an exemplary embodiment, test script 201 is a software module written using Cucumber language, a plain English but executable open source language, available at http://cucumber.io. Test script 201 drives test automation framework 202 which comprises a digital analytics handler 203. Digital analytics handler 203 comprises one or more processors configured to control three distinct components: (1) web page controller 204; (2) web/page plug-in switcher 205; and (3) plug-in controller 206. In exemplary embodiments, these components may be in the form of distinct controllers or software modules.

Web page controller 204 simulates user actions on internet web page 207. In at least one exemplary embodiment, the web page controller 204 is programmed using Selenium Webdriver, open source software available at http://www.seleniumhq.org/projects/webdriver/. Other browser controllers such as eggPlant Functional, Kantu or QF-Test may also be used. Web page 207 may be the web page of a web browser such as Mozilla Firefox, Microsoft Internet Explorer or Google Chrome.

Plug-in controller 206 is used to control plug-in 208 and collect the values received by plug-in 208 and pass them through digital analytics handler 203 to the analytics system 250. In at least one exemplary embodiment, the plug-in controller is programmed using AutoIt, a freeware controller available at https://www.autoitscript.com/site/autoit/. Other plug-in controllers such as Ascentialtest, Dojo Objective Harness, or eggPlant Functional can also be used. However, those plug-in controllers cannot be used stably because those tools use locations of user interface elements to control the plug-in which can be changed depending on screen and browser resolutions and the existence or lack of the tool bar. Plug-in 208 may be a digital analytics web browser plug-in such as IBM® Digital Analytics, from IBM Corp.

Web page/plug-in switcher 205 is used to switch operations between web page controller 104 and plug-in controller 206. In at least one exemplary embodiment, web page/plug-in switcher 205 uses software such as AutoIt to transfer controls between the web page and the plug-in.

Web page/plug-in switcher 205 first determines whether the plug-in is open and if not then it opens plug-in 208. In an exemplary embodiment, the plug-in is opened by opening the plug-in using the menu bar of the web browser 115 (not shown). Once the plug-in is open, web page/plug-in switcher 205 sends control to plug-in controller 206. In an exemplary embodiment, control is passed to plug-in controller 206 using a series of key-strokes which passes control from web page 207 to plug-in 208. Alternatively the control can be passed using mouse control, however this is not as desirable because mouse control can be unpredictable where web pages are presented on various sized monitors.

Once control is passed to plug-in controller 206, plug-in controller completes the required steps necessary to pass the tag values to analytics system 250. Once the tag values are passed, web page/plug-in switcher 205 returns control to the web page. In one exemplary embodiment, control is passed to the web page using mouse controls to click on the title bar. In another exemplary embodiment, keyboard controls can be used to click on the title bar. Once the title bar is toggled, the web page is active and web page controller 204 can be used as needed.

Test automation system 200, is communicatively coupled to analytics system 250 through digital analytics handler 203 and exchanges data with analytics system 250 through application server 251. In an exemplary embodiment, test automation system resides on one computer or computer network and analytics system 250 resides on a separate computer network and the two are connected via the internet. Alternatively both test automation system 200 and analytics system 250 can reside on the same computer network.

Analytics system 250 includes application server 251 which is connected to database 252 which stores both master key data 253 and new data 254. Browser plug-in test results are presented on monitor 260, which may be any type of conventional monitor.

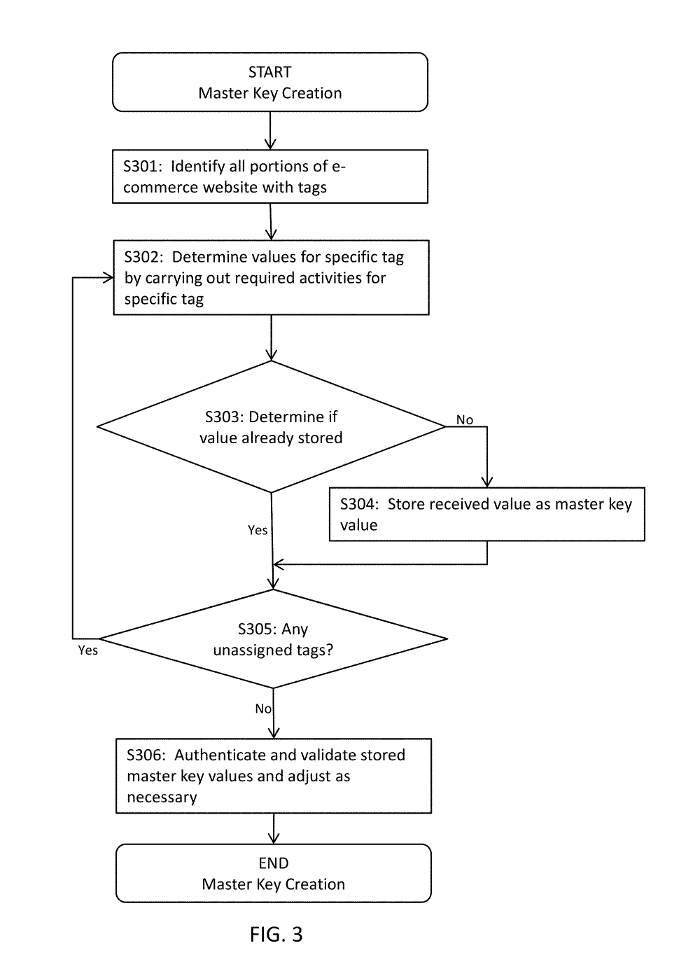

FIG. 3 illustrates the steps required for master key creation. In step s301, all tags are identified which will contain values representing outcomes for each action on the electronic commerce website. Tags are assigned manually by a programmer. In an exemplary embodiment, the tags assigned are defined by a library which is part of the plug-in.

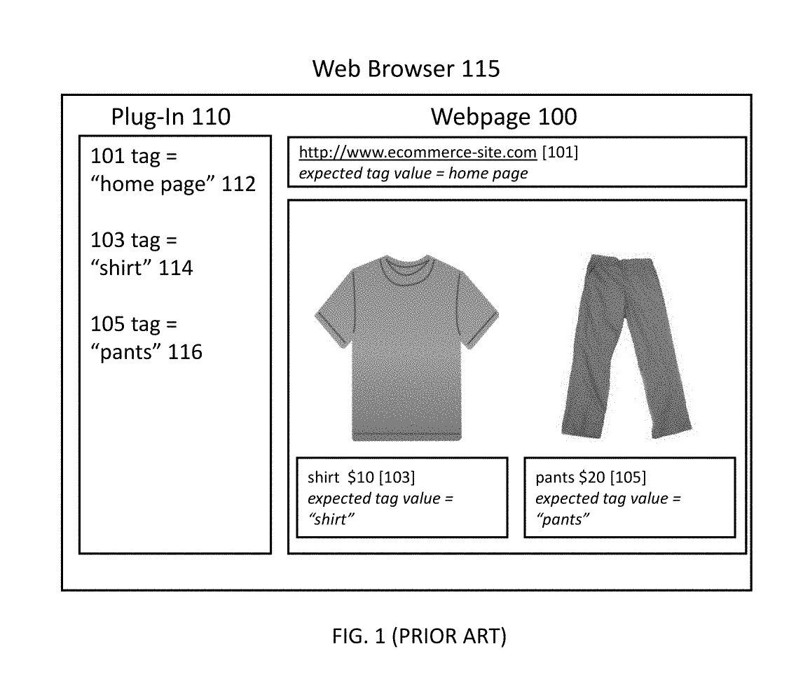

The tag values are determined serially as shown in step s303 of FIG. 3. For example, referring to FIG. 1, tag value 112 of “home page” is determined first. In step s303, a check is conducted to determine whether the “home page” tag has been stored as master key data 253 of database 252 in analytics system 250. If not, as indicated in step s304, the value is stored. This could be stored in a database or simply on a sheet of paper. The process continues until each tag value, such as shirt 114 and pants 116 in the example illustrated in FIG. 1, is stored.

Once there are no remaining unassigned tags, as shown by step s306, the tag values are reviewed in step s306 to ensure that the master key values are the desired values. For example, with reference to the illustration of FIG. 1, if a tag value of “jacket” was received for tag 104, the tag value in the master key database would need modification to read the proper value of “shirt”. In a preferred embodiment, the underlying source code would be reviewed and corrected so that the proper value of “shirt” is output when a user clicks on the shirt in FIG. 1.

Embodiments of the present invention may be operated as part of a system for testing e-commerce web analytical plug-in operations.

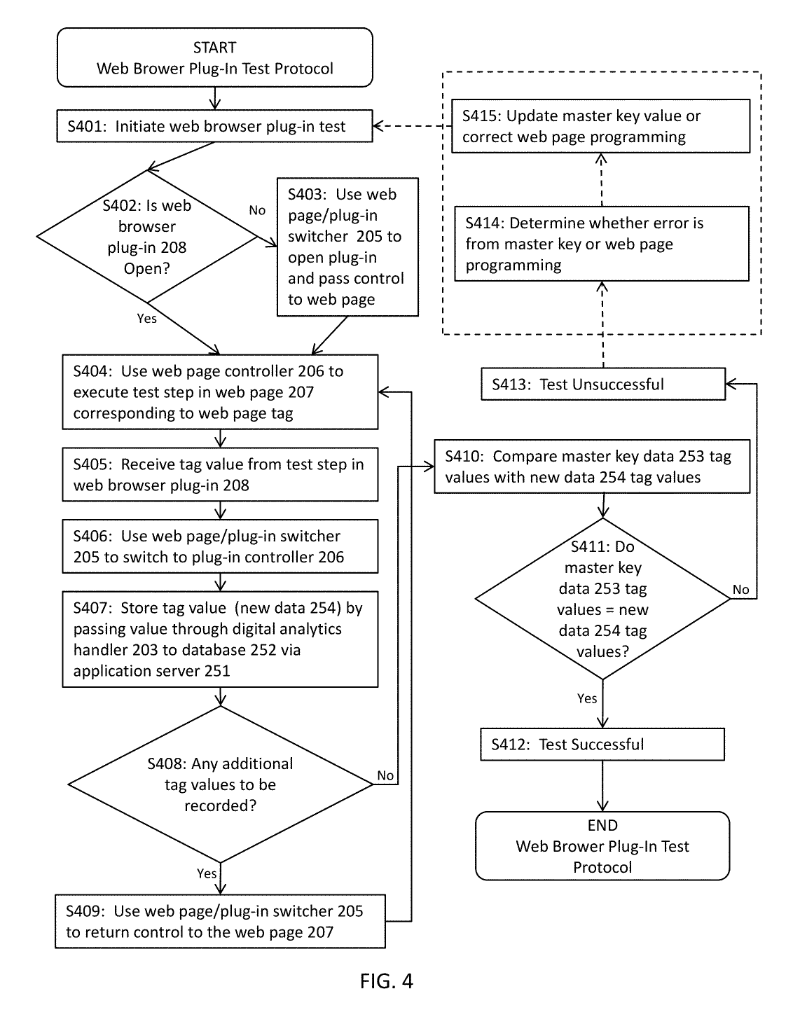

FIG. 4 is a flow chart illustrating exemplary process steps performed by the web browser test automation system in an embodiment where master key values are already created (for example, by the process described in FIG. 3) and stored in database 252. With reference to FIGS. 2 and 4, the web browser plug-in test protocol is illustrated. At step s401, the web browser plug-in test is initiated by initiating test script 201.

Test script 201 would initiate test automation framework 202. In step s402, a check is made to determine whether the web browser plug-in 208 is open. If it is not open, web page/plug-in switcher 205 opens plug-in 208 in step s403 and then passes control to the web page.

Once it is confirmed that plug-in 208 is open, as indicated by step s404, web page controller 204 will simulate user actions in web page 207 which will populate values for the tags in web page 207.

In step s405, the tag values will then be received by plug-in 208.

For example, with reference to FIG. 1, browser controller would simulate going to the home page www.ecomerrce-site.com, and clicking on “shirt $10” and “pants $20” which will populate the tag fields of “home page” 112, “shirt” 114, and “pants” 116 in plug-in 110.

In step s406, web page/plug-in switcher 205 switches control from web page controller 204 to plug-in controller 206.

Plug-in controller 206 is used to control plug-in 208 and collect the values received by plug-in 208 and pass them through digital analytics handler 203 to analytics system 250.

As seen in step s407, plug-in controller 206 operates to take the tag value from plug-in 208 and pass the value, through digital analytics handler 203 to database 252 via application server 251, which is part of analytics system 250. The tag value is stored in database 252 as new data 154. As seen in step s408, steps s404 through s407 are repeated until all tag values have been passed and stored as new data 154. In an alternative embodiment, all tag values can be populated using web page controller 204 and passed to the plug-in before plug-in controller passes those values to database 252 to be stored as new data 254.

As seen in step s409, control is switched back to the web page as needed by web page/plug-in switcher 205 to complete the web browser plug-in testing.

Once the tag values are all stored as new data 254, as seen in step s410, master key data 253 values are compared with new data 254 values. If the values match, as seen in steps s411 and s412, then the test is successful. The results of this testing may be illustrated to the developer on monitor 260. If, as illustrated in step s411 and s413, the values don't match, then the test is unsuccessful. At that point, as indicated by steps s414 and s415, which are not part of the testing protocol, a web browser developer would debug the system to determine if the master key value is in error, or there is a problem in the electronic commerce website and make the appropriate adjustments before restarting the web browser plug-in test protocol.

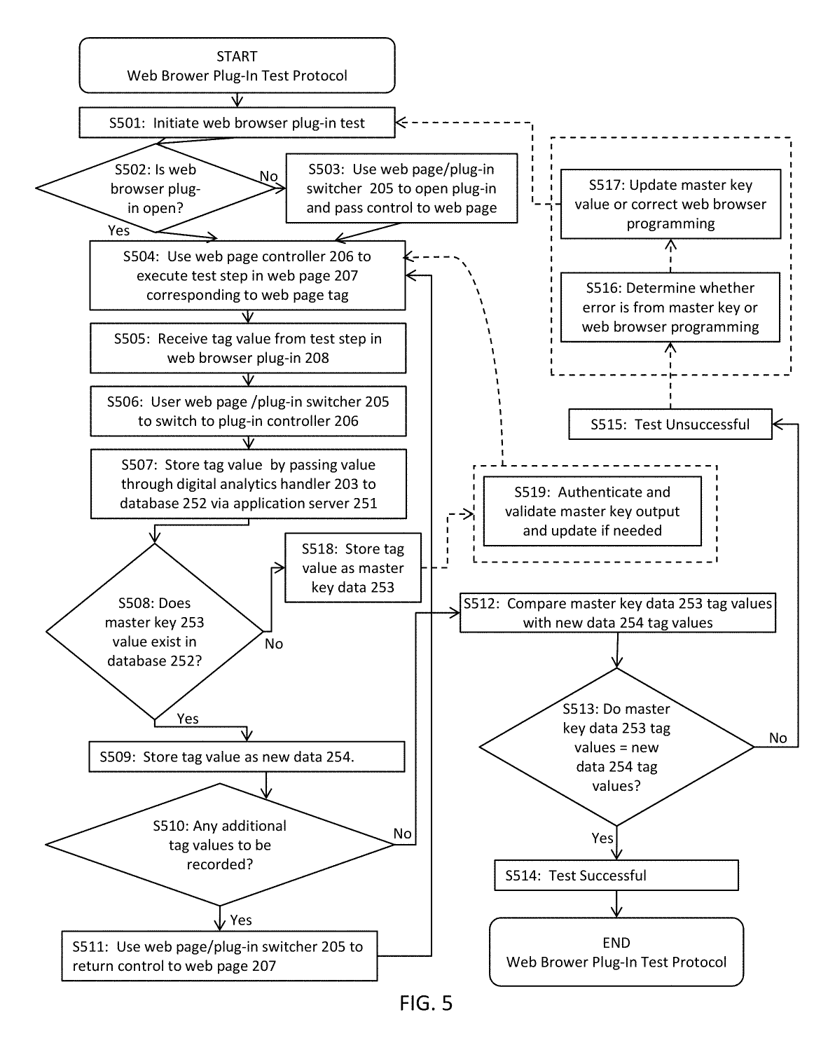

In an alternative embodiment, illustrated in FIG. 5, master key data 253 values are populated in database 252 by executing a run of the web browser plug-in test protocol. The web browser plug-in testing commences at step s501 similar to step s401 in FIG. 4. In step s502, there is a check to wee whether the web browser plug-in is open, and if it is not, as seen in step s503, web page/plug-in switcher 205 opens the plug-in before passing control back to the web page.

Once control is back to the web page, as seen in step s504, web page controller 206 executes a test step in web page 207 corresponding to a web page tag. In Step s505 the tag value is received in web browser plug-in 208. In step s506, the web page/plug-in switcher 105 is switched to plug-in controller 206 which in step s505 stores the tag value.

In step s507 after the tag value is passed through digital analytics handler 203 to database 252 via application server 251, a check is made in step s508 to determine whether master key data 253 exists in database 252. If a master key data exists in database 252, the tag value is stored in step s509 as new data 254 and the web browser plug-in test protocol proceeds in the same manner as in FIG. 4.

However, if no master key data related to the particular tag is stored in database 252, the tag value is stored as master key data in database 252. The plug-in test protocol can then return to step s504 (not shown) after web page/plug-in switcher 205 returns control back to the web page (not shown) and the process is repeated until all of the master key data values are populated. As shown in step s519, the master key values must be reviewed to determine if they are the desired values, if the master key values are not authenticated and verified at any point under this scenario, the values will never differ from the new data values as even if a wrong data value is received it would be received during the second iteration of the test protocol. Once the master key values are in place and verified, the test protocol proceeds until all the new data 254 tag values have been stored in database 252.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed:

1. A computer implemented method for testing a plug-in associated with a web browser, comprising the steps of:
(a) maintaining, by a computer system including at least one computer, a database in one or more memories storing master key values associated with a web page in the web browser;
(b) placing, by the computer system, a control in the web page;
(c) simulating, by the computer system, user actions in the web page to generate tag values corresponding to portions of the web page selected by the simulated user actions;
(d) receiving, by the computer system, the generated tag values at the plug-in;
(e) switching, by the computer system, the control from the web page to the plug-in;
(f) transferring, by the computer system, the generated tag values from the plug-in to the database; and
(g) comparing, by the computer system, the generated tag values to the corresponding master key values stored in the database.

2. The computer implemented method of claim 1, further comprising the step of opening, by the computer system, the plug-in prior to the step (b).

3. The computer implemented method of claim 1, wherein the step (c) comprises simulating, by the computer system, clicking on the selected portions of the web page.

4. The computer implemented method of claim 1, wherein the step (d) comprises populating, by the computer system, tag fields corresponding to the selected portions of the web page in the plug-in.

5. The computer implemented method of claim 1, wherein the step (f) comprises storing, by the computer system, the generated tag values as new data in the database.

6. The computer implemented method of claim 1, wherein the step (e) comprises using one or more key-strokes or a mouse control in the computer system.

7. The computer implemented method of claim 1, further comprising, after the step (f), switching, by the computer system, the control from the plug-in to the web page.

8. The computer implemented method of claim 7, wherein the step of switching the control from the plug-in to the web page comprises using a keyboard control or a mouse control of the computer system to activate a title bar of the web page.

9. The computer implemented method of claim 1, further comprising presenting, by the computer system, a result of the step (g) on a monitor.

10. A system comprising:
one or more memories;
one or more processors operatively connected to the one or more memories; and
one or more non-transitory processor readable storage media operatively connected to the one or more processors and having stored thereon executable instructions that are executable by the one or more processors to cause the system to perform a method for testing a plug-in associated with a web browser, the method comprising the steps of:
(a) maintaining a database in the one or more memories storing master key values associated with a web page in the web browser;
(b) placing a control in the web page;
(c) simulating user actions in the web page to generate tag values corresponding to portions of the web page selected by the simulated user actions;
(d) receiving the generated tag values at the plug-in;
(e) switching the control from the web page to the plug-in;
(f) transferring the generated tag values from the plug-in to the database; and
(g) comparing the generated tag values to the corresponding master key values stored in the database.

11. A computer implemented method for testing a plug-in associated with a web browser, comprising the steps of:
(a) maintaining, by a computer system including at least one computer, a database in one or more memories for storing data associated with a web page in the web browser;
(b) placing, by the computer system, a control in the web page;
(c) simulating, by the computer system, a user action in the web page to generate a tag value corresponding to a portion of the web page selected by the simulated user action;
(d) receiving, by the computer system, the generated tag value at the plug-in;
(e) switching, by the computer system, the control from the web page to the plug-in;
(f) transferring, by the computer system, the generated tag value from the plug-in to the database;
(g) if the database has a master key value corresponding to the selected portion of the web page, storing, by the computer system, the generated tag value in the database as new data and comparing, by the computer system, the generated tag value to the corresponding master key value stored in the database; and if the database does not have the master key value, storing, by the computer system, the generated tag value in the database as the master key value and repeating the steps (b)-(g).

12. The computer implemented method of claim 11, wherein the step of storing the generated tag value in the database as the master key value if the database does not have the master key value comprises authenticating and validating the master key value.

13. The computer implemented method of claim 11, further comprising the step of opening, by the computer system, the plug-in prior to the step (b).

14. The computer implemented method of claim 11, wherein the step (c) comprises simulating, by the computer system, clicking on the selected portion of the web page.

15. The computer implemented method of claim 11, wherein the step (d) comprises populating, by the computer system, a tag field corresponding to the selected portion of the web page in the plug-in.

16. The computer implemented method of claim 11, wherein the step (e) comprises using one or more key-strokes or a mouse control in the computer system.

17. The computer implemented method of claim 11, further comprising, after the step (f), switching, by the computer system, the control from the plug-in to the web page.

18. The computer implemented method of claim 17, wherein the step of switching the control from the plug-in to the web page comprises using a keyboard control or a mouse control of the computer system to activate a title bar of the web page.

19. The computer implemented method of claim 11, further comprising presenting, by the computer system, a result of the step of comparing the generated tag value to the corresponding master key value on a monitor.
